(19) United States
(12) Patent Application Publication
(10) Pub. No.: US 2020/0226270 A1
(43) Pub. Date: Jul. 16, 2020

(54) SYSTEM AND METHOD FOR MULTILAYER DATA PROTECTION FOR MEMORY DEVICES

(71) Applicant: Hewlett Packard Enterprise Development LP, Houston, TX (US)

(72) Inventor: MELVIN K. BENEDICT, Houston, TX (US)

(21) Appl. No.: 16/364,714

(22) Filed: Mar. 26, 2019

Related U.S. Application Data
(60) Provisional application No. 62/792,300, filed on Jan. 14, 2019.

(51) Int. Cl. G06F 21/60; H04L 9/32; G06F 3/06; G06F 11/10

(52) U.S. Cl. CPC G06F 21/602; H04L 9/3226; G06F 3/0623; G06F 11/1004; G06F 3/0673; G06F 11/1076; G06F 3/0659

(57) ABSTRACT

Systems and methods are provided for multi-layer data protection for memory devices. The method comprises receive data, generate an authentication code based on the data, encrypt the data and the authentication code, and write the encrypted data and authentication code to a memory device.

### CROSS REFERENCE TO RELATED APPLICATIONS

This application claims the benefit of U.S. Provisional Application No. 62/792,300, filed Jan. 14, 2019, and which is incorporated herein by reference in its entirety.

### DESCRIPTION OF RELATED ART

The disclosed technology relates generally to electronic computer systems, and more particularly to data protection and validation in such systems.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 shows a memory system according to one embodiment of the disclosed technology.

FIG. 2 is a flow diagram for providing multilayer data protection for memory devices during a write operation in accordance with one embodiment.

FIG. 3 is a flow diagram for providing multilayer data protection for memory devices during a read operation in accordance with one embodiment.

FIG. 4 is a flowchart depicting a method for the memory controller of FIG. 1 for providing multilayer data protection for memory devices during a write operation in accordance with one embodiment.

FIG. 5 is a flowchart depicting a method for the memory controller of FIG. 1 for providing multilayer data protection for memory devices during a read operation in accordance with one embodiment.

FIG. 6 provides further detail of the method of FIG. 4.

FIG. 7 provides further detail of the method of FIG. 5.

The figures are not exhaustive and do not limit the present disclosure to the precise form disclosed.

### DETAILED DESCRIPTION

Various embodiments of the disclosed technology provide multilayer data protection for memory devices. Current volatile memory devices generally include buffer and register logic that may be modified by an attacker to observe or modify the data stored in the memory devices. The disclosed technology provides a memory controller that implements a multilayer strategy to defeat such attacks.

During a write operation, the memory controller may first generate an authentication code based on the data to be written to the memory device. Next, the memory controller may concatenate the data and authentication code, and encrypt the concatenation. Finally, the encrypted concatenation may be written to the memory device. Although an attacker may gain access to the data stored in the memory device, that data will be encrypted, and therefore will be of no use to the attacker. A similar process may be used during a read operation, where the authentication code may be used to verify the data has not been modified by an attacker.

The technology described herein provides several advantages. Implementation of the disclosed technology eliminates the need for a secure channel to the memory devices. Instead, the data is protected through generation of an authentication code, and encryption of the data and authentication code. The elimination of the secure data channel reduces the total cost of the memory system for a secure platform.

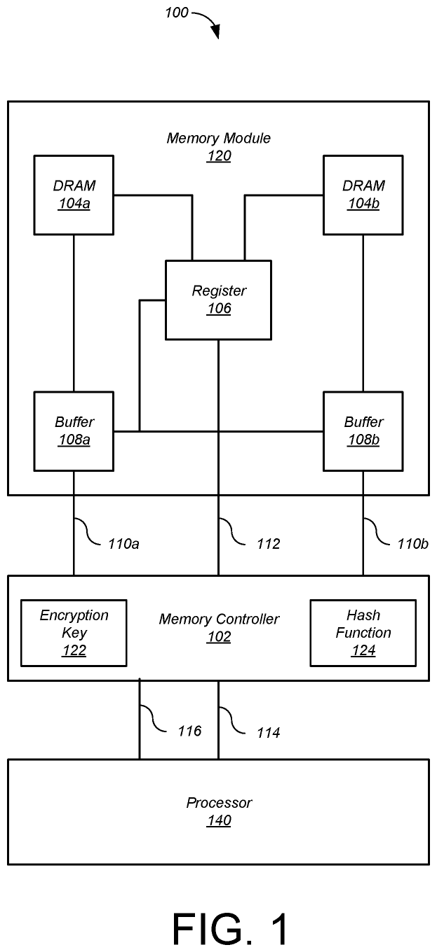

FIG. 1 shows a computing system according to one embodiment of the disclosed technology. Referring to FIG. 1, the computing system 100 may include a memory controller 102 and a memory module 120. The memory module 120 may include one or more memory devices, for example such as dynamic random-access memories (DRAM) 104a, b. While the memory module 120described has two memory devices 104a, b, the disclosed technology may be applied to memory modules having any number of memory devices. And while various embodiments are described for protecting data stored in DRAM, the disclosed technology may be used to protect data stored in other sorts of volatile memory devices, for example such as load reduced memory devices, three-dimensional stack memory devices, memristor memory devices, and the like. But currently none of these technologies provide methodologies for data validation. The disclosed technology may be used to protect data stored in nonvolatile memory devices as well. The computing system 100 may include a processor 140. In some embodiments, the memory controller 102 may be housed within the processor 140.

The memory controller 102 may store an encryption key 122. The memory controller 102 may use the encryption key 122 to encrypt data written to the memory module 120, and to decrypt data read from the memory module 120, for example as described below. The encryption key 122 may be provisioned with the memory controller 102, provided by the processor 140, or a combination thereof. When provided by the processor 140, the encryption key 122 may be supplied via the system bus 114, via a separate management channel 116, or the like. The memory controller 102 may store a plurality of encryption keys 122. For example, different encryption keys 122 may be used with different processes, different users, and the like, or combinations thereof.

The memory controller 120 may store a hash function 124. The memory controller 120 may use the hash function 124 to generate authentication codes for data written to the memory module 120, and to validate data read from the memory module 120. The hash function 124 may be provisioned with the memory controller 102, provided by the processor 140, or a combination thereof. When provided by the processor 140, the hash function 124 may be supplied via the system bus 114, via a separate management channel 116, or the like. The memory controller 120 may store multiple hash functions 124. For example, different hash functions 124 may be used with different processes, different users, and the like, or combinations thereof.

The DRAMs 104 may feature extra bits that may be employed by embodiments of the disclosed technology. For example, the DRAMs 104 may be connected to the memory controller using a 40 bit wide data bus, providing 32 bits for data and 8 bits for error correction or an authentication code. This provides about 3 extra bits per transfer for authentication code storage compared to a 72 bit wide data bus. Embodiments of the disclosed technology may employ the extra bits to store an authentication code that is generated based on the data in the data line, for example as described below.

Referring again to FIG. 1, the memory module 120 may include a buffer 108a,b for each DRAM 104a,b. Each buffer 108a,b may include logic to buffer data between a DRAM 104a,b and a data bus 110a,b. The memory module 120 may include a register 106. The register 106 may include logic to control the buffers 108a,b and the DRAMs 104a,b in accordance with command signals and address signals provided by the memory controller 102 over a command/address bus 112. A system bus 114 provides communications between the memory controller 102 and other elements of a computing system (not shown), for example such as processors, network interfaces, displays, input devices, other storage devices, and the like. For example, the computing system 100 may include a processor 140, and the system bus 114 provides communications between the memory controller 102 and the processor 140.

In some embodiments, the memory module 120 of FIG. 1 may be implemented as a plurality of integrated circuit chips disposed upon a printed circuit board. In some embodiments, the computing system 100 of FIG. 1 may be implemented as a system-on-a-chip. However, the implementation of the computing system 100 of FIG. 1 is not limited to these implementations, which are provided only by way of example.

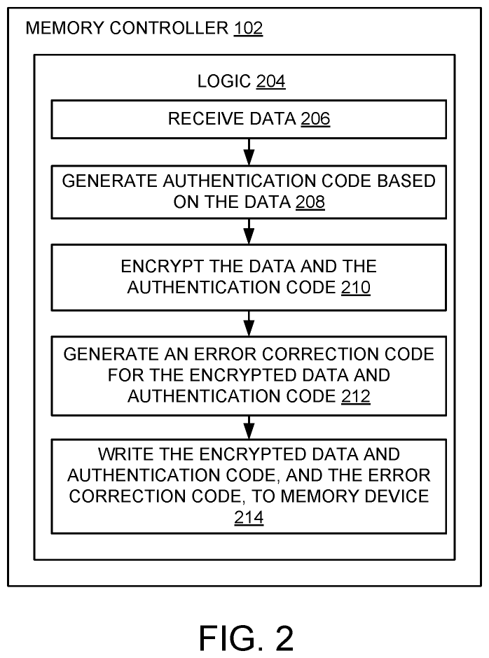

FIG. 2 is a flow diagram for the memory controller 102 of FIG. 1 for providing multilayer data protection for memory devices during a write operation in accordance with one embodiment. Memory controller 102 may include one or more electronic circuits that include electronic components to implement the logic 206-214 of FIG. 2, such as hardware state machines, field programmable gate arrays (FPGAs), application specific integrated circuit (ASICs), or other electronic circuits. In other implementations, some or all of the logic 206-214 may be implemented using controllers or processors executing instructions such as firmware stored on a non-transitory computer readable medium.

Referring to FIG. 2, memory controller 102 may use logic 206 to receive data into the memory controller 102 over the system bus 114. The data may be provided by a processor or the like. The data may be accompanied by a checksum or the like for ensuring the integrity of the data. The checksum may be generated outside the computing system 100 of FIG. 1. For example, the checksum may be generated by a system providing the data to the computing system 100.

Memory controller 102 may use logic 208 to generate an authentication code based on the received data. For example, the authentication code may be generated by hashing the data. In one implementation, the hash may be a modulo 256 hash. However, other hash functions, and other functions may be used to generate the authentication code.

Memory controller 102 may use logic 210 to encrypt the data and the authentication code. In some embodiments, the data and the authentication code may be encrypted using a private key that is stored within the memory controller 102. In such embodiments, because the private key is not stored in the DRAMs 104, register 106, or buffers 108, that private key is not available to an attacker, thereby enhancing the security of the data stored in the DRAMs 104.

The data and authentication code may be concatenated prior to encryption. Any encryption technique may be used. Of course, the strength of the data protection will increase with the strength of the encryption used. In embodiments where a checksum is received with the data, the data, authentication code, and checksum may be encrypted together. The data, authentication code, and checksum may be concatenated prior to encryption.

Memory controller 102 may use logic 212 to generate an error correction code for the encrypted data and authentication code. In embodiments where a checksum is received with the data, and encrypted with the data and authentication code, the error correction code may be generated for the encrypted data, authentication code, and checksum. Memory controller 102 may use logic 214 to write the encrypted data and authentication code, and the error correction code, to the memory device 104. For example, the memory controller 102 may provide a memory address, and a write command, over the command/address bus 112, to the register 106, while providing the encrypted data and authentication code to a buffer 108 over a data bus 110.

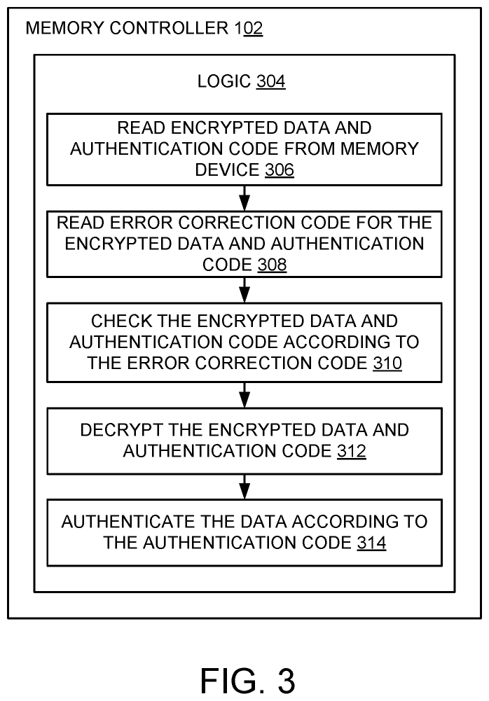

FIG. 3 is a flow diagram for the memory controller 102 of FIG. 1 for providing multilayer data protection for memory devices during a read operation in accordance with one embodiment. Memory controller 102 may include one or more electronic circuits that include electronic components for performing the functionality of the logic 306-314 of FIG. 3, such as a hardware state machine, field programmable gate array (FPGA), application specific integrated circuit (ASIC), or other electronic circuits.

Referring to FIG. 3, memory controller 102 may use logic 306 to read encrypted data and authentication code from a memory device 104. For example, the memory controller 102 provides a memory address, and a read command, over the command/address bus to the register 106. In response, the register 106 causes a buffer 108 to provide data from a DRAM 104 over a data bus 110.

Memory controller 102 may use logic 308 to read an error correction code for the encrypted data and authentication code. Memory controller 102 may use logic 310 to check the encrypted data and authentication code according to the error correction code. This check may be implemented according to conventional techniques.

Memory controller 102 may use logic 312 to decrypt the encrypted data and authentication code. The encrypted data, authentication code and checksum (if one) may be decrypted using a private key that is stored in the memory controller 102.

Memory controller 102 may use logic 314 to authenticate the data according to the authentication code. For example, the function used to generate the authentication code during write operations may be applied to the decrypted data, and the results compared to the decrypted authentication code. This process ensures the data has not been modified by an attacker.

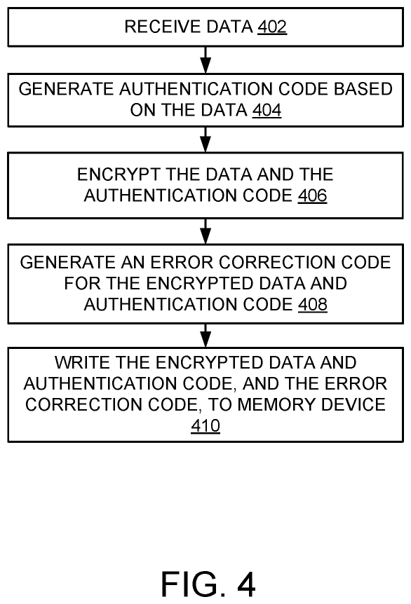

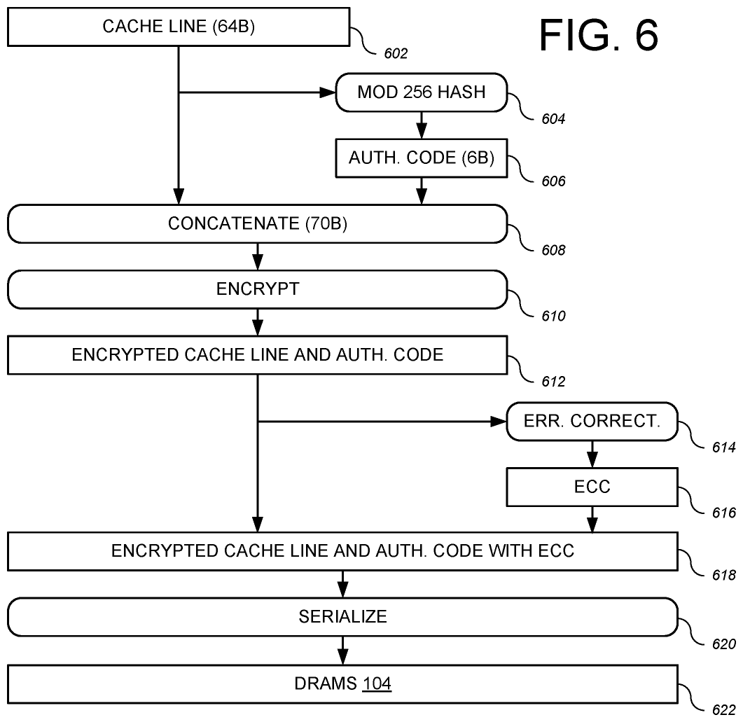

FIG. 4 is a flowchart depicting a method for the memory controller 102 of FIG. 1 for providing multilayer data protection for memory devices during a write operation in accordance with one embodiment. FIG. 6 provides further detail of the method of FIG. 4. Referring to FIG. 4, memory controller 102 may receive data over the system bus 114, at 402. The data may be provided by the processor 140 or the like. Referring to FIG. 6, the data may be a cache line sized chunk of data (e.g., 64 bytes), at 602. The data may be accompanied by a checksum or the like for ensuring the integrity of the data. The checksum may be generated outside the computing system 100 of FIG. 1. For example, the checksum may be generated by a system providing the data to the computing system 100.

Referring again to FIG. 4, the memory controller 102 may generate an authentication code based on the received data, at 404. For example, the authentication code may be generated by hashing the data. In some embodiments, the cache line sized chunk of data is hashed to produce the authentication code. The authentication code may be small enough to fit into the extra bits provided by the data bus once serialization into 40 bit transfers occurs. The hash may be a simple checksum such as a count of the 1's in the cache line. The hash may be a modulo x hash. Referring to FIG. 6, in one implementation, the hash may be a modulo 256 hash, resulting in a six-byte authentication code, at 604. The hash may be a cryptographically secure hash function. The hash and associated parameters may be kept secret in the memory controller 102. The memory controller 102 may accept parameters for the cryptographically secure hash, so that different memory controllers 102 may use different unique hash functions. However, other hash functions, and other functions may be used to generate the authentication code. In some embodiments, the output at this stage is 70 bytes.

Referring again to FIG. 4, the memory controller 102 may encrypt the data and the authentication code, at 406. In some embodiments, the data and the authentication code may be encrypted using a private key that is stored within the memory controller 102. That is, the cache line sized chunk of data and the authentication code are concatenated and then encrypted using a key private to the memory controller 102. The key might be specific to the user, application or process. The encrypted output is the same size as the input, so the output at this stage is 70 bytes. In such embodiments, because the private key is not stored in the DRAMs 104, register 106, or buffers 108, that private key is not available to an attacker, thereby enhancing the security of the data stored in the DRAMs 104.

Referring to FIG. 6, the data and authentication code may be concatenated prior to encryption, at 608. Any encryption technique may be used. Of course, the strength of the data protection will increase with the strength of the encryption used. In embodiments where a checksum is received with the data, the data, authentication code, and checksum may be encrypted together. The data, authentication code, and checksum may be concatenated prior to encryption.

Referring again to FIG. 4, the memory controller 102 may generate an error correction code for the encrypted data and authentication code, at 408. Referring again to FIG. 6, the 70 bytes of encrypted cacheline and authentication code are run through an ECC function 614 to generate 10 ECC bits, at 616, which are then concatenated to the 70 bytes of encrypted cacheline and authentication code. The output at this stage is 80 bytes, at 618. In embodiments where a checksum is received with the data, and encrypted with the data and authentication code, the error correction code may be generated for the encrypted data, authentication code, and checksum.

Referring again to FIG. 4, the memory controller 102 may write the encrypted data and authentication code, and the error correction code, to the memory device 104, at 410. For example, the memory controller 102 may provide a memory address, and a write command, over the command/address bus 112, to the register 106, while providing the encrypted data and authentication code to a buffer 108 over a data bus 110. Referring again to FIG. 6, the 80 bytes may be serialized into a string of smaller transfers (e.g., 40 bit transfers), at 620, which are then written to the DRAMs 104, at 622.

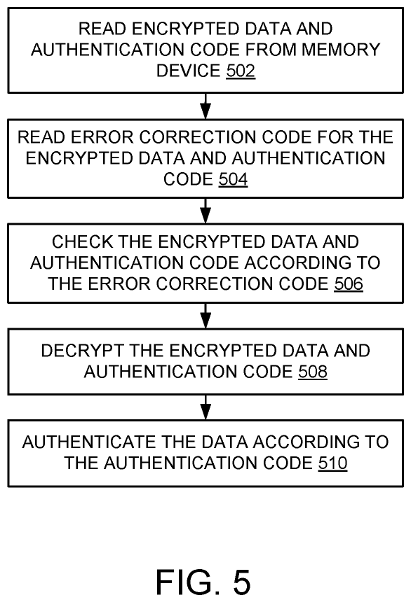

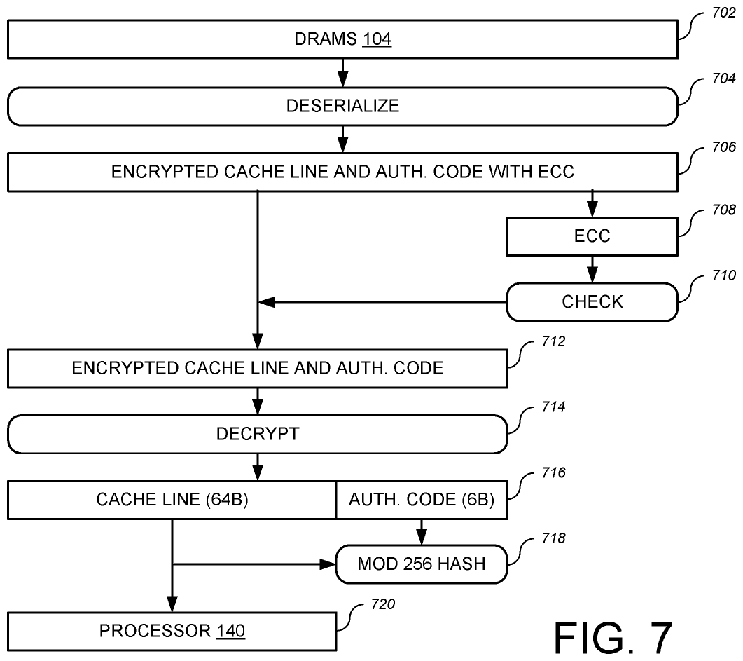

FIG. 5 is a flowchart depicting a method for the memory controller 102 of FIG. 1 for providing multilayer data protection for memory devices during a read operation in accordance with one embodiment. FIG. 7 provides further detail for the method of FIG. 5. Referring to FIG. 5, memory controller 102 may read encrypted data and authentication code from a memory device 104, at 502. For example, the memory controller 102 provides a memory address, and a read command, over the command/address bus to the register 106. Referring to FIG. 7, in response, the register 106 causes a buffer 108 to provide data from a DRAM 104 over a data bus 110, at 702. The memory controller 102 may deserialize data, at 704, to generate the encrypted cache line and authentication code with ECC, at 706.

Referring to FIGS. 5 and 7, the memory controller 102 may read an error correction code for the encrypted data and authentication code, at 504 and 708. Memory controller 102 may check the encrypted data and authentication code according to the error correction code, at 506 and 710. This check may be implemented according to conventional techniques. The checked encrypted cache line and authentication code are shown at 712.

Memory controller 102 may decrypt the encrypted data and authentication code, at 508 and 714. The encrypted data, authentication code and checksum (if one) may be decrypted using a private key that is stored in the memory controller 102. The resulting decrypted cache line and authentication code are shown at 716.

Memory controller 102 may authenticate the data according to the authentication code, at 510. For example, the hash function 718 used to generate the authentication code during write operations may be applied to the decrypted data, and the results compared to the decrypted authentication code, verifying that the computed authentication value of the cache line after decode matches the decoded authentication value from the packet. This process ensures the data has not been modified by an attacker. The cache line may then be provided to the processor 140, at 720.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 400.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A memory system comprising:
a memory device to store data;
a buffer to buffer the data;
a register to control the memory device and the buffer in accordance with address signals and command signals;
a memory controller to
provide the address signals and the command signals to the register,
receive data,
generate an authentication code based on the received data,
encrypt the data and the authentication code, and
write the encrypted data and authentication code to the memory device.

2. The memory system of claim 1, wherein the memory controller is further to:
generate an error correction code for the encrypted data and the authentication code ; and
write the encrypted data and authentication code, and the error correction code, to the memory device.

3. The memory system of claim 1, wherein the memory controller is further to:
concatenate the data and the authentication code prior to encrypting the data and the authentication code.

4. The memory system of claim 1, wherein, to generate the authentication code based on the received data, the memory controller is further to:
hash the data.

5. The memory system of claim 1, wherein the memory controller is further to:
receive a checksum for the received data;
encrypt the data, the authentication code, and the checksum; and
write the encrypted data, authentication code, and checksum to the memory device.

6. The memory system of claim 1, wherein the memory controller is further to:
read encrypted further data and further authentication code from the memory device;
decrypt the encrypted further data and further authentication code; and
verify the further data according to the further authentication code.

7. The memory system of claim 6, wherein the memory controller is further to:
read, from the memory device, an error correction code for the encrypted further data and further authentication code ; and
check the encrypted further data and further authentication code, according to the error correction code, prior to decrypting the encrypted further data and further authentication code.

8. A memory system comprising:
storage to store data;
a buffer to buffer the data;
a register means to control the memory device and the buffer in accordance with address signals and command signals;
a memory controller, comprising
logic to provide the address signals and the command signals to the register,
logic to receive data,
logic to generate an authentication code based on the received data,
logic to encrypt the data and the authentication code, and
logic to write the encrypted data and authentication code to the memory device.

9. The memory system of claim 1, wherein the memory controller further comprises:
logic to generate an error correction code for the encrypted data and authentication code; and
logic to write the encrypted data and authentication code, and the error correction code, to the memory device.

10. The memory system of claim 1, wherein the memory controller further comprises:
logic to concatenate the data and the authentication code prior to encrypting the data and the authentication code.

11. The memory system of claim 1, wherein the logic to generate the authentication code based on the received data further comprises:
logic to hash the data.

12. The memory system of claim 1, wherein the memory controller further comprises:
logic to receive a checksum for the received data;
logic to encrypt the data, the authentication code, and the checksum; and
logic to write the encrypted data, authentication code, and checksum to the memory device.

13. The memory system of claim 1, wherein the memory controller further comprises:
logic to read encrypted further data and further authentication code from the memory device;
logic to decrypt the encrypted further data and further authentication code; and
logic to verify the further data according to the further authentication code.

14. The memory system of claim 6, wherein the memory controller further comprises:
logic to read, from the memory device, an error correction code for the encrypted further data and further authentication code; and
logic to check the encrypted further data and further authentication code, according to the error correction code, prior to decrypting the encrypted further data and further authentication code.

15. A method for a memory controller, the method comprising:
receive data,
generate authentication code based on the received data,
encrypt the data and the authentication code, and
write the encrypted data and authentication code to a memory device.

16. The method of claim 15, further comprising:
generate an error correction code for the encrypted data and authentication code; and
write the encrypted data and authentication code, and the error correction code, to the memory device.

17. The method of claim 15, further comprising:
concatenate the data and the authentication code prior to encrypting the data and the authentication code.

18. The method of claim 15, further comprising:
receive a checksum for the data;
encrypt the data, the authentication code, and the checksum; and
write the encrypted data, authentication code, and checksum to the memory device.

19. The method of claim 15, further comprising:
read encrypted further data and further authentication code from the memory device;
decrypt the encrypted further data and further authentication code; and
verify the further data according to the further authentication code.

20. The method of claim 19, further comprising:
read, from the memory device, an error correction code for the encrypted further data and further authentication code; and
check the encrypted further data and further authentication code, according to the error correction code, prior to decrypting the encrypted further data and further authentication code.
